(19) United States
(12) Patent Application Publication
(10) Pub. No.: US 2005/0116529 A1
(43) Pub. Date: Jun. 2, 2005

(54) Shopping cart wheel

(76) Inventors: Terry Swanson, Plattsmouth, NE (US); Larry Swanson, Plattsmouth, NE (US)

Correspondence Address: Law Offices Of Adam H. Jacobs, Suite 726, 1904 Farnam Street, Omaha, NE, 68102, US

(21) Appl. No.: 10/725,725

(22) Filed: Dec. 2, 2003

(51) Int. Cl. B60B 25/00

(52) U.S. Cl. 301/10.1

(57) ABSTRACT

The present invention provides an improved shopping cart wheel which includes a wheel hub supporting a wheel thereon and having a central axial opening. Mounted within the central axial opening adjacent one end thereof is a first precision bearing unit having a rotating cylindrical central hub, an outer toroidal bearing jacket surrounding the central hub and a plurality of ball bearings rotatably mounted within the outer toroidal bearing jacket and rotatably supporting the rotating central hub therebetween, and mounted within the central axial opening adjacent the opposite end thereof is a second precision bearing unit which is substantially identical to the first precision bearing unit. The central hubs of the first and second precision bearing units generally contact one another in coaxial alignment within the central axial opening such that the improved shopping cart wheel will withstand greater side load forces and have increased weight-carrying capacity.

### BACKGROUND OF THE INVENTION

1. Technical Field

The present invention relates to wheels for shopping carts and, more particularly, to an improved shopping cart wheel, including a wheel hub supporting a wheel thereon and having a central axial opening, an first precision bearing unit having a rotating cylindrical central hub, an outer toroidal bearing jacket surrounding the central hub and a plurality of ball bearings rotatably mounted within the bearing jacket for rotatably supporting the central hub there between, an second precision bearing unit similar to the first precision bearing unit, the first and second precision bearing units mounted within the central axial opening of the wheel hub generally contacting one another to provide increased weight capacity and greater side load withstanding capability.

2. Description of the Prior Art

When the average consumer visits a grocery store to purchase groceries, little thought is given to the shopping cart into which the groceries are placed prior to purchase. However, unless the shopping cart functions correctly for the shopper, the entire shopping experience is made much more difficult and it is even likely that the consumer will cease to shop at the particular store where the inconvenience was encountered. Therefore, there is a need to make shopping carts as reliable and maintenance free as possible to increase consumer satisfaction with the shopping experience and decrease maintenance costs to the grocery store.

Of all of the elements of the shopping cart, it is the shopping cart wheels which undergo the most stress and strain during the lifespan of the shopping cart and, in fact, it is the shopping cart wheels which force the retirement of many shopping carts from active duty. Particularly with the proliferation of discount stores such as Sam's Club® and other such wholesale outlets, the amount and weight of groceries being purchased is increasing, thus resulting in additional strain and stress being placed on the shopping cart wheels. Also, due to the high-pressure washing systems used to clean shopping carts, the wheels, and particularly the wheel bearings, are often denuded of lubricant which can decrease the lifespan of the shopping cart wheel. Finally, shopping cart wheels are exposed to a great deal of side stress due to the sliding of the wheels sideways on the floor surface during cornering of the shopping cart, which further increases the stress loads placed on the wheels and wheel bearings of the shopping cart wheel. There is therefore a need for an improved shopping cart wheel which will better withstand the increased weight demands and increased side forces applied to the wheels to increase the lifespan of the wheel and decrease maintenance costs to the grocery store.

Various wheels have been proposed in the prior art, such as Hicks, U.S. Pat. No. 5,690,395 and Kern et al., U.S. Pat. No. 5,871,286, each of which attempt to address and solve the problems of increased weight demands and increased wear on the wheels, but do not fully solve either of the problems for various reasons which are inherent in their designs. Consequently, there is still a need for an improved shopping cart wheel which will address and solve the problems not solved by those wheels found in the prior art.

Therefore, an object of the present invention is to provide an improved shopping cart wheel.

Another object of the present invention is to provide an improved shopping cart wheel which includes two precision bearing units mounted in the central axial opening of the wheel to greatly improve the weight capacity and side load capacity of the wheel.

Another object of the present invention is to provide an improved shopping cart wheel in which the first and second precision bearing units are each mounted adjacent opposite ends of the central axial opening of the wheel hub with the central hubs of each of the precision bearing units contacting one another to greatly increase the structural strength of the shopping cart wheel.

Another object of the present invention is to provide an improved shopping cart wheel which is superior to those wheels found in the prior art, yet also is relatively economical in construction to permit its widespread use.

Finally, an object of the present invention is to provide an improved shopping cart wheel which is relatively simple and inexpensive in construction and is safe, efficient, and durable in use.

### SUMMARY OF THE INVENTION

The present invention provides an improved shopping cart wheel which includes a wheel hub supporting a wheel thereon and having a central axial opening having inner and outer sides. Mounted within the central axial opening adjacent one end thereof is a first precision bearing unit having a rotating cylindrical central hub, an outer toroidal bearing jacket surrounding the central hub and a plurality of ball bearings rotatably mounted within the outer toroidal bearing jacket and rotatably supporting the rotating central hub therebetween, and mounted within the central axial opening adjacent the opposite end thereof is an second precision bearing unit having a rotating cylindrical central hub, an outer toroidal bearing jacket surrounding the central hub and a plurality of ball bearings rotatably mounted within the outer toroidal bearing jacket and rotatably supporting the rotating central hub therebetween. The central hub of the first precision bearing unit is generally contacting the central hub of the second precision bearing unit within the central axial opening in generally coaxial alignment such that the improved shopping cart wheel will withstand greater side load forces and have increased weight-carrying capacity.

The improved shopping cart wheel as thus described provides several advantages not found in the prior art. For example, the use of the precision bearings will greatly decrease the maintenance needs of the wheel thus increasing the lifespan of the wheel and reducing the maintenance costs for operation of the wheel and hence the cart on which the wheel is mounted. Also, the design and construction of the wheel is such that the cost per unit is kept affordable, which permits the wheel of the present invention to be used in a greater number of situations. Finally, because the improved shopping cart wheel of the present invention provides greater capacity to withstand side load forces without failing and further includes increased weight-carrying capacity, it is superior to those wheels found in the prior art. It is thus seen that the improved shopping cart wheel of the present invention provides a substantial improvement over those devices found in the prior art.

### BRIEF DESCRIPTION OF THE DRAWINGS

FIG. 1 is a perspective view of the improved shopping cart wheel of the present invention mounted on a shopping cart;

FIG. 2 is a detail perspective view of the improved shopping cart wheel of the present invention; and

FIG. 3 is a front sectional elevational view of the improved shopping cart wheel showing the precision bearings within the central axial opening of the wheel hub.

### DESCRIPTION OF THE PREFERRED EMBODIMENT

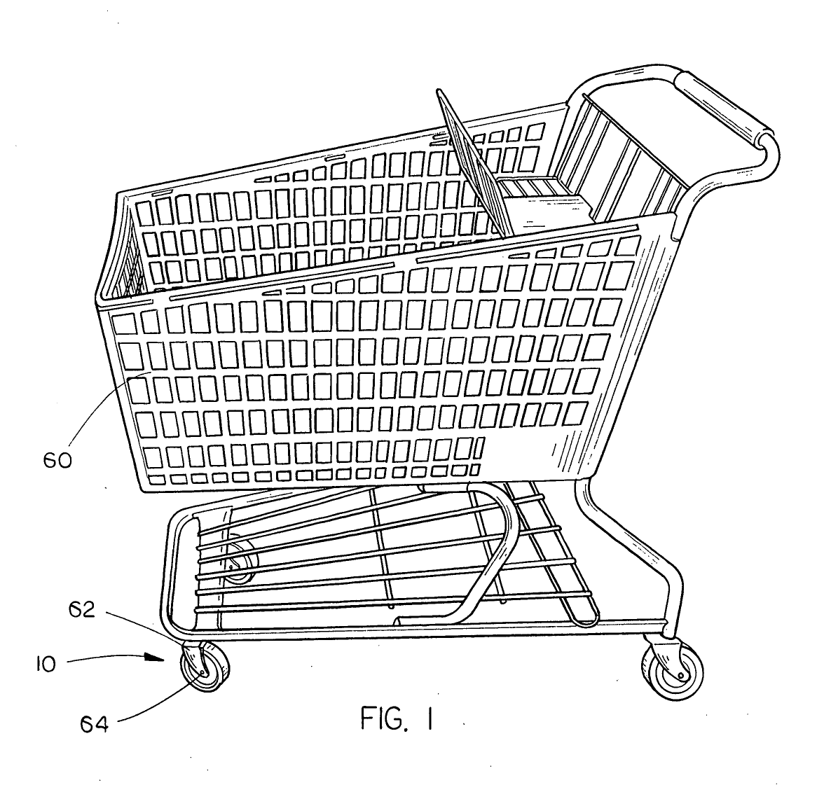

The improved shopping cart wheel 10 of the present invention is shown best in FIGS. 1, 2 and 3 as including a wheel hub 12 on which is circumferentially mounted a wheel 50 which, in the preferred embodiment, would be constructed of metal, plastic such as polyurethane or a rubber compound, depending on the intended use of the shopping cart wheel. In the preferred embodiment, the wheel hub 12 would be molded from a high-impact plastic such as polypropylene and further includes a central axial opening 14 which, in the preferred embodiment, is generally cylindrical in shape extending perpendicularly through the wheel hub 12 in coaxial alignment with the rotational axis of the wheel hub 12.

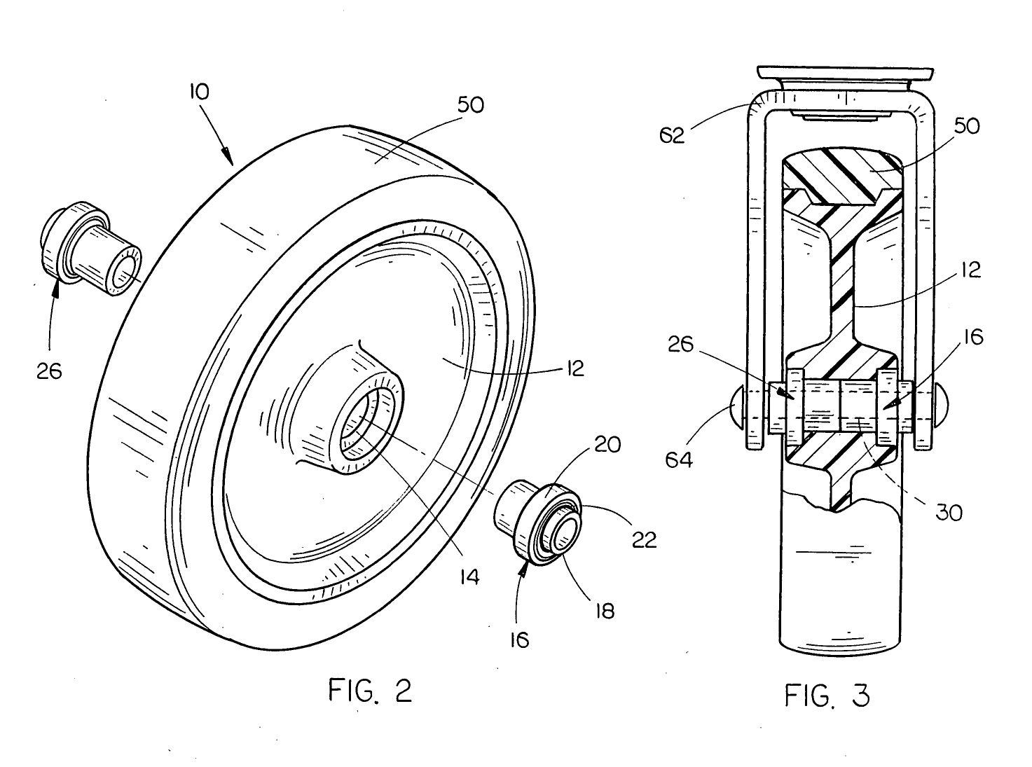

Mounted within central axial opening 14 are a pair of precision bearing units, a first precision bearing unit 16 mounted adjacent one side of central axial opening 14 and a second precision bearing unit 26 mounted adjacent the opposite side of central axial opening 14, as shown best in FIGS. 2 and 3. As each of the first and second precision bearing units 16 and 26 are preferably identical, the following description of first precision bearing unit 16 should be understood to apply equally to second precision bearing unit 26. First precision bearing unit 16 preferably includes a rotating cylindrical central hub 18 which is rotatably mounted within an outer generally toroidal bearing jacket 20, as shown best in FIGS. 2 and 3. The bearing jacket 20 is preferably generally square U-shaped in cross section to provide a channel in which rotatably reside a plurality of ball bearings 22 which rotatably support the central hub 18 therebetween. It is further preferred that the ball bearings 22 be Teflon-coated or the like to minimize friction and also reduce the need for lubrication for the ball bearings 22. In the preferred embodiment, the central hub 18 would have a diameter of approximately one centimeter and a length of approximately two centimeters, and the diameter of bearing jacket 20 would be approximately two centimeters, although the specific dimensions of the bearing unit elements is not critical to the present invention so long as the functionality of the bearing unit is maintained. For example, it may be preferable to include a larger bearing unit 16 in the case of use of a larger wheel hub 12 to decrease friction and increase the lifespan of the shopping cart wheel 10.

It should be noted that, in the preferred embodiment, central axial opening 14 of wheel hub 12 would include a step configuration wherein the outer ends of central axial opening 14 have a greater diameter than the inner connecting section of central axial opening 14. The primary purpose for this is to insure that the first and second precision bearing units 16 and 26 fit snugly and securely into the central axial opening 14 to minimize as much as possible wobble motion of the shopping cart wheel 10 when it is mounted on the shopping cart 60. Of course, it should also be noted that the exact dimensions of the central axial opening 14 may be modified or changed to accommodate various shaped bearing units 16 and 26 merely by modifying the mold from which the wheel hub 12 is produced.

The shopping cart wheel 10 of the present invention is shown as being mounted on a shopping cart 60 by a swivel bracket 62 through which a mounting pin 64 is extended, as shown best in FIGS. 1 and 3. The mounting pin 64 extends through the central hubs 18 of first and second precision bearing units 16 and 26 such that the improved shopping cart wheel 10 is rotatably mounted on the mounting pin 64 on swivel bracket 62. Of course, many other types of mounting brackets and systems may be used in connection with the improved shopping cart wheel 10 of the present invention, any of which would be understood by one skilled in the art.

It is the unique combination of the first and second precision bearing units 16 and 26 mounted within the central axial opening 14 of wheel hub 12 that render the present invention superior to those wheels found in the prior art. For example, the dual precision bearings permit the shopping cart wheel 10 to support an increased amount of weight over those wheels found in the prior art and, furthermore, because the precision bearings 16 and 26 are mounted adjacent the opposite sides of the central axial opening 14 of wheel hub 12, improved resistance to side load conditions which tend to damage shopping cart wheels is obtained. Also, the bearing units 16 and 26 are sealed, which means that the incursion of foreign objects into the bearing units 16 and 26 is generally prevented. Finally, because of the relatively simple construction of the shopping cart wheel 10 of the present invention, the cost for construction of the shopping cart wheel is greatly reduced, thus permitting its use in many different situations where such an improved wheel would not otherwise be available for use.

It should be noted that it is contemplated to include a plastic cover (not shown) to be mounted on each of the opposite sides of the wheel hub 12 completely covering and enclosing the first and second precision bearing units 16 and 26 to protect them and generally prevent the incursion of contaminants which will degrade the performance of the bearing units, although the exact size and shape of the plastic cover will be determined on a case-by-case basis depending on the structure and format of the wheel itself. Also, it is further contemplated to include a cylindrical steel spanner 30 which extends between and connects the central hubs 18 of first and second precision bearing units 16 and 26 for additional structural strength of the improved shopping cart wheel 10, and although the inclusion of such a steel spanner unit is not critical to the present invention, it is desirable.

It is to be understood that numerous additions, substitutions, and modifications may be made to the improved shopping cart wheel 10 of the present invention which fall within the intended broad scope of the appended claims. For example, the precise size, shape, and construction materials used in connection with the wheel 10 are not critical so long as the functional features described herein are maintained. Furthermore, the precise nature of the first and second precision bearing units 16 and 26 is only somewhat critical to the present invention so long as the units are precision bearing units having the functional characteristics of a precision bearing in order to insure proper functionality of the improved shopping cart wheel 10 of the present invention. Finally, although the present invention has been described for use in connection with shopping carts, it should be noted that the wheel may be used with other types of carts, any of which would be understood by those skilled in the art.

There has therefore been shown and described an improved shopping cart wheel 10 which accomplishes at least all of its intended objectives.

1. An improved shopping cart wheel comprising:
a wheel hub supporting a wheel thereon and having a central axial opening having inner and outer sides;
a first precision bearing unit having a rotating cylindrical central hub, an outer toroidal bearing jacket surrounding said central hub and a plurality of ball bearings rotatably mounted within said outer toroidal bearing jacket and rotatably supporting said rotating central hub therebetween;
a second precision bearing unit having a rotating cylindrical central hub, an outer toroidal bearing jacket surrounding said central hub and a plurality of ball bearings rotatably mounted within said outer toroidal bearing jacket and rotatably supporting said rotating central hub therebetween;
said first and second precision bearing units mounted within said central axial opening of said wheel hub with said first precision bearing unit adjacent one end of said central axial opening and said second precision bearing unit adjacent the opposite end of said central axial opening; and
said central hub of said first precision bearing unit contacting said central hub of said second precision bearing unit in generally coaxial alignment within said central axial opening such that said improved shopping cart wheel will withstand greater side load forces and have increased weight-carrying capacity.

2. The improved shopping cart wheel of claim 1 further comprising a generally cylindrical metal spanner mounted within said central axial opening and extending between and connecting said rotating central hubs of said first and second precision bearing units such that the structural strength of said improved shopping cart wheel is increased.

3. The improved shopping cart wheel of claim 1 wherein said central axial opening of said wheel hub further comprises a cross-sectional step configuration wherein the outer ends of said central axial opening are of greater diameter than the inner connecting section of said central axial opening such that said first and second precision bearing units fit snugly and securely into said central axial opening thereby minimizing wobble motion of said improved shopping cart wheel when it is mounted on a shopping cart.

4. The improved shopping cart wheel of claim 1 wherein said outer toroidal bearing jackets of said first and second precision bearing units are each generally square U-shaped in cross section to provide a channel in which rotatably reside said plurality of ball bearings which respectively rotatably support said central hubs of said first and second precision bearing units therebetween.

5. The improved shopping cart wheel of claim 1 wherein said first and second precision bearing units are each sealed to generally prevent incursion of foreign objects into said first and second precision bearing units and the need for lubrication of said first and second precision bearing units is generally eliminated.

6. In combination:
a shopping cart including a plurality of wheel-mounting brackets, each of which further includes a mounting pin operative to rotatably mount a wheel on one of said plurality of wheel-mounting brackets; and
an improved shopping cart wheel comprising:
a wheel hub supporting a wheel thereon and having a central axial opening having inner and outer sides;
a first precision bearing unit having a rotating cylindrical central hub, an outer toroidal bearing jacket surrounding said central hub and a plurality of ball bearings rotatably mounted within said outer toroidal bearing jacket and rotatably supporting said rotating central hub therebetween;
a second precision bearing unit having a rotating cylindrical central hub, an outer toroidal bearing jacket surrounding said central hub and a plurality of ball bearings rotatably mounted within said outer toroidal bearing jacket and rotatably supporting said rotating central hub therebetween;
said first and second precision bearing units mounted within said central axial opening of said wheel hub with said first precision bearing unit adjacent one end of said central axial opening and said second precision bearing unit adjacent the opposite end of said central axial opening; and
said central hub of said first precision bearing unit generally adjacent said central hub of said second precision bearing unit in generally coaxial alignment within said central axial opening such that said improved shopping cart wheel will withstand greater side load forces and have increased weight-carrying capacity.

7. An improved shopping cart wheel comprising:
a wheel hub supporting a wheel thereon and having a central axial opening having inner and outer sides;
a first precision bearing unit having a rotating cylindrical central hub, an outer toroidal bearing jacket surrounding said central hub and a plurality of ball bearings rotatably mounted within said outer toroidal bearing jacket and rotatably supporting said rotating central hub therebetween;
a second precision bearing unit having a rotating cylindrical central hub, an outer toroidal bearing jacket surrounding said central hub and a plurality of ball bearings rotatably mounted within said outer toroidal bearing jacket and rotatably supporting said rotating central hub therebetween;
said first and second precision bearing units mounted within said central axial opening of said wheel hub with said first precision bearing unit adjacent one end of said central axial opening and said second precision bearing unit adjacent the opposite end of said central axial opening; and
a generally cylindrical metal spanner extending between and connecting said central hubs of said first and second precision bearing units in generally coaxial alignment within said central axial opening such that said improved shopping cart wheel has increased durability.
